(19) United States
(12) Patent Application Publication
(10) Pub. No.: US 2006/0037450 A1
(43) Pub. Date: Feb. 23, 2006

(54) Flying saw and flighted chain conveyor apparatus

(76) Inventors: Ronald H. Pobuda, Salmon Arm (CA); Roland Davyduke, Salmon Arm (CA); Tony A. Plowman, Salmon Arm (CA); Ryan E. Webber, Salmon Arm (CA)

Correspondence Address: ANTONY C. EDWARDS, SUITE 200 - 270 HIGHWAY 33 WEST, KELOWNA, BC, V1X 1X7, CA

(21) Appl. No.: 11/204,025

(22) Filed: Aug. 16, 2005

Related U.S. Application Data
(60) Provisional application No. 60/601,970, filed on Aug. 17, 2004.

(51) Int. Cl. B23D 25/00; B26D 1/56

(52) U.S. Cl. 83/368; 83/371; 83/287; 83/289; 144/357

(57) ABSTRACT

An apparatus for sawing a workpiece on predetermined cutting lines while the workpiece is being continuously transported in a downstream direction includes first and second conveyors having a spaced array of workpiece elevating supports mounted on at least the second conveyor translating for the workpiece in the downstream direction, at least one saw mounted on corresponding saw transports adjacent the second conveyor, a workpiece scanner and a data processor and controller for processing the data received from the scanner; determining the position of the cut lines; for controlling the relative phase positions of the first and second conveyors such that the cut lines do not coincide with the position of the workpiece elevating supports; and for actuating downstream translation of the saw on the saw transport so as to align the saw with the cut lines as the workpiece and the saw are translated downstream in unison while the saw cuts the through workpiece at the cut lines without contacting the underlying conveyor.

### CROSS REFERENCE TO RELATED APPLICATION

This application claims priority from U.S. Provisional Patent Application No. 60/601,970 filed Aug. 17, 2004.

### FIELD OF THE INVENTION

This invention relates to the field of sawmill machinery and in particular to an apparatus for use in transporting, scanning, and sawing logs on an uninterrupted basis using a log-scanning and flying-saw mechanism combined with a flighted chain conveyor.

### BACKGROUND OF THE INVENTION

A common sawmill procedure is to send a log or stem of wood down a conveyor and subsequently make cuts across the width of the stem so as to divide the stem into appropriate lengths for subsequent processing. In the so-called “cutoff saw system” known in the prior art, the stem travels endwise down a conveyor and when the conveyor operator decides a cut should be made, he/she actuates a “log stop” which blocks the forward motion of the stem. The forward end of the stem strikes and abuts the log stop, the conveyor is shut down, and a saw or saws are engaged to make the desired cut. The log stop is then removed from the path of the stem, the conveyor reactivated and the stem continues its downstream motion until the next desired cut. As may be seen, a difficulty with this system is that it is cumbersome and slow in that it requires constant turning on and off of the conveyor, resulting in sawmill production inefficiencies.

In the so-called “slasher deck system” known in the prior art, stems are similarly conveyed downstream on conveyors. The stems pass underneath a series of saws spaced sequentially at predetermined increments. When a stem reaches the desired position under the saws, the conveyor may be stopped and the saws are displaced into the stem to make several desired cuts at once. Problems with this type of system are two-fold: the system occupies a large space and the system is difficult to adjust to accurately space the saws such that all the cuts are made at the desired intervals. Again, as in the cut-off saw system, the conveyor must be stopped prior to cuts being made.

It is further known in the prior art to have sawing systems wherein stems or logs which are to be sawn travel continuously through the sawing system while sawing takes place. A flying saw travels in parallel with the stem to the desired sawing location where the stem is then sawn “on the fly”. In this regard, applicant is aware of U.S. Pat. No. 4,640,160 entitled “Sweep-Data-Responsive, High-Speed, Continuous-Log-Travel Bucking Apparatus” which issued to Hards on Feb. 3, 1987, and U.S. Pat. No. 4,616,542 entitled “Flying Bucksaw Apparatus” which issued to Hards on Oct. 14, 1986. These patents teach an apparatus for sawing a log while the log is being directed in an endwise, continuous downstream path of travel on a series of two belt conveyors. The apparatus includes saw means for sawing the log, means for displacing the saw means into and out of the path of log travel, clamp means for releasably gripping the log, and means for reciprocating the saw means and the clamp means along the path of travel. Further included in the apparatus are control means including apparatus for, among other functions, causing the clamp means to grip the log only when the clamp is travelling at a desired velocity and for causing the clamp to release the log after a cut has been effected.

A difficulty inherent in the use of conveyor belts in the prior art, is the possibility of having the saw cut through the stem and continue on to cut into the underlying conveyor belt. Because a stem lies directly on the belt in such systems, there is only a small margin of error between a saw cutting completely through a stem and yet not cutting so far that the saw hits the conveyor belt directly underneath the stem. This difficulty is overcome in the apparatus of the Hards patents by the use of the two conveyor belts of differing heights. The stem travels along the infeed and higher conveyor belt until it is clamped towards the end of the infeed conveyor belt prior to release onto the lower, outfeed conveyor belt. The saw blade completes its cutting path through the stem downstream of the downstream end of the infeed conveyor belt, either in the gap between the two conveyor belts or when the stem is suspended above the outfeed conveyor belt. Thus, the system is highly dependent on the proper functioning of the clamping means to tightly grip and hold the stem without fail. The cut must also be made within a limited spatial area.

It is therefore an object of the present invention to provide a continuous, flying saw conveyor apparatus for the sawing of stems that may operate without the need to clamp the stems being sawn. It is a further object of the present invention to provide such an apparatus supporting multiple saws that may cut a stem anywhere along the length of the conveyor assembly.

### SUMMARY OF THE INVENTION

In summary, the apparatus according to the present invention for sawing a workpiece on predetermined cutting lines while the workpiece is being continuously transported in a downstream direction includes first and second transport means for the workpiece, at least one sawing means mounted on corresponding saw transport means, workpiece scanning means and data processing and control means.

The first transport means is for translating the workpiece in a downstream direction. The first transport means may include a first conveyor chain which may have a plurality of spaced apart workpiece elevating supports such as chain flights mounted to and extending above the first conveyor chain. The supports extend upwardly from the first conveyor chain so as to cradle the workpiece spaced above the first conveyor chain. Thus, the workpiece when translating on the first transport means rests on the chain flights elevated above the first conveyor chain.

The second transport means is for translating the workpiece in the downstream direction once handed-off from the upstream first transport means. The second transport means may include a second conveyor chains having a plurality of spaced apart workpiece elevating supports such as chain flights mounted to and extending above the second conveyor chain. The second chain flights extend upwardly from the second conveyor chains so as to cradle the workpiece spaced above the second conveyor chain. Thus the workpiece when translating on the second transport means rests on the second chain flight elevated above the second conveyor chain.

The sawing means is mounted on a corresponding saw transport means for sawing the workpiece on predetermined cut lines while the workpiece translates continuously in the downstream direction. The saw transport means is for translating the sawing means downstream parallel to the workpiece while the workpiece is translating downstream. A selectively actuable saw actuator is mounted to the saw transport means for selectively actuating the sawing means so as to saw through the workpiece on the cut lines without contacting the underlying conveyor.

The scanning means is adjacent the first transport means for detecting location and characteristics of the workpiece and for conveying corresponding data to a data processing and control means. The data processing and control means performs a number of tasks including: processing the data received from the scanning means; determining the position of the cutting lines; for controlling the relative phase positions of the first and second conveyor chains such that the cutting lines do not coincide with the position of the second chain flights; and for actuating downstream translation of the sawing means on the saw transport means so as to align cutting devices such as tracking saws on the sawing means with the cutting lines as the workpiece and the sawing means are translated downstream in unison while the saws cut the through workpiece without contacting the underlying conveyor.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is, in plan view, a flying saw and the flighted chain conveyor system of the present invention.

FIG. 2 is, in side elevation view, the system of FIG. 1.

FIG. 3 is an enlarged plan view of the scanner and upstream first conveyor of FIG. 1.

FIG. 4 is an enlarged plan view of the downstream end of the first conveyor of FIG. 1.

FIG. 5 is an enlarged plan view of the upstream end of the second conveyor of FIG. 1.

FIG. 6 is an enlarged plan view of one flying drop saw of FIG. 1.

FIG. 7 is an enlarged plan view of the downstream end of the second conveyor of FIG. 1.

FIG. 8 is, in side elevation, the view of FIG. 3.

FIG. 9 is, in side elevation, the view of FIG. 4.

FIG. 10 is, in side elevation, the view of FIG. 5.

FIG. 11 is, in side elevation, the view of FIG. 6.

FIG. 12 is an enlarged portion of FIG. 4.

FIG. 12a is the enlarged portion of FIG. 12 in perspective partially cutaway view.

FIG. 13 is, in partially cutaway plan view, the portion of FIG. 12a

FIG. 14 is, in partially cutaway side elevation view, the portion of FIG. 13.

FIG. 15 is a cross-sectional view along line 15-15 in FIG. 14.

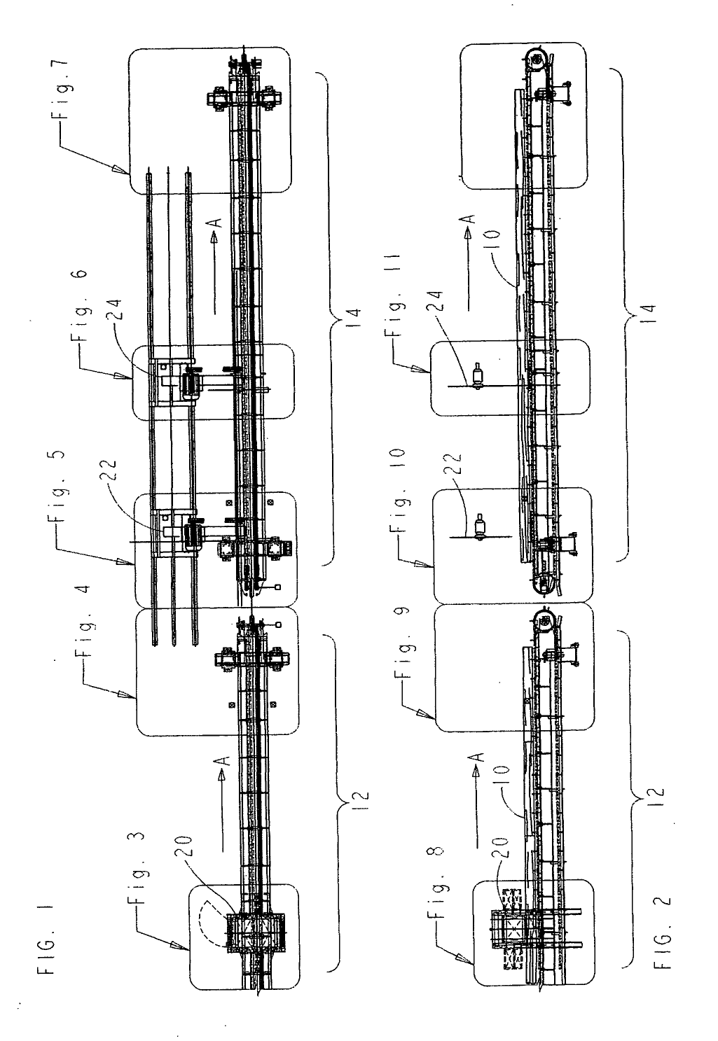

### DETAILED DESCRIPTION OF EMBODIMENTS OF THE INVENTION

With reference to the drawings wherein similar characters of reference denote corresponding parts in each view, the flying saw and flighted chain conveyor system of the present invention for transporting and sawing a stem 10 includes first and second conveyors 12 and 14 respectively although this is not intended to be limiting as three or more conveyors according to the present invention may be employed. Only two conveyors are illustrated for simplicity. Stem 10 is transported along conveyor 12 in downstream direction A, moving from first conveyor 12 to second conveyor 14.

Each of conveyors 12 and 14 may include a conventional chain conveyor 18a and 18b respectively, formed by the continuous sequential linkage of adjacent chain links to form a continuous chain. Chain flights 16, which maybe “I”-shaped chain flights, are sequentially spaced along each of conveyors 12 and 14 and extend from chains 18a and 18b. During its transport along conveyors 12 and 14, stem 10 rests on chain flights 16, so that stem 10 rests above the highest point of chains 18a and 18b.

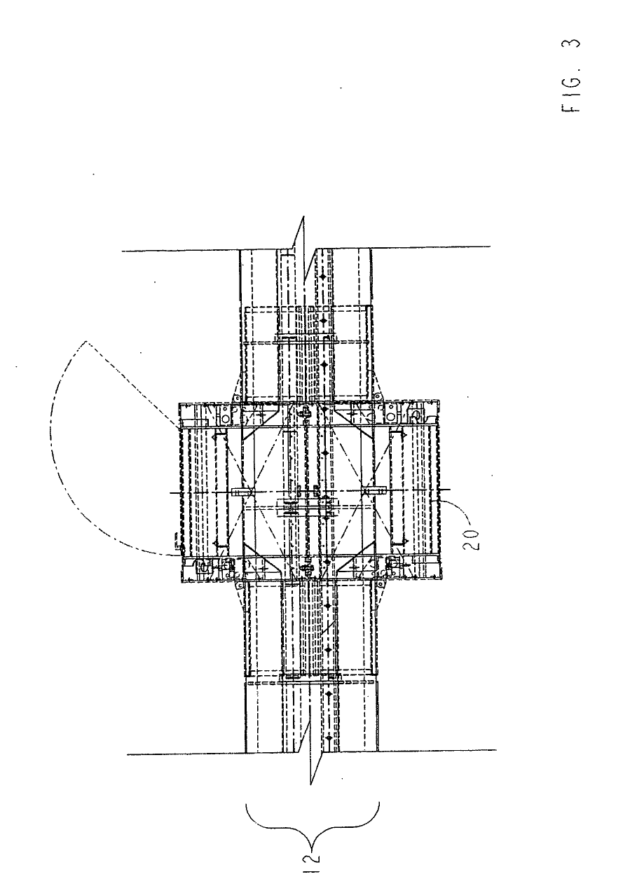

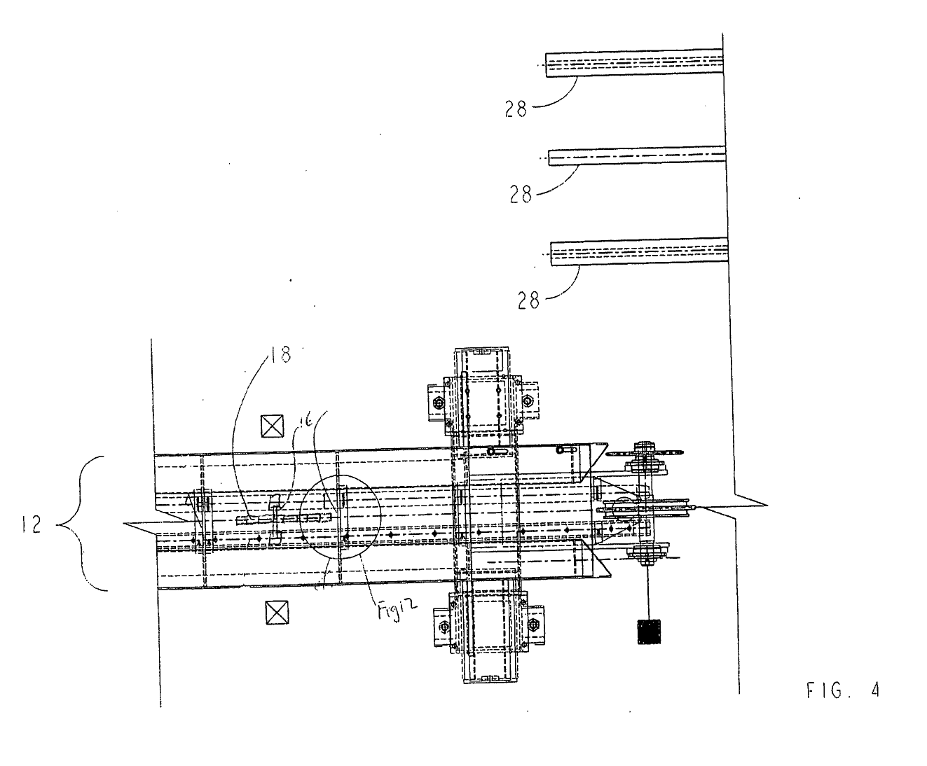

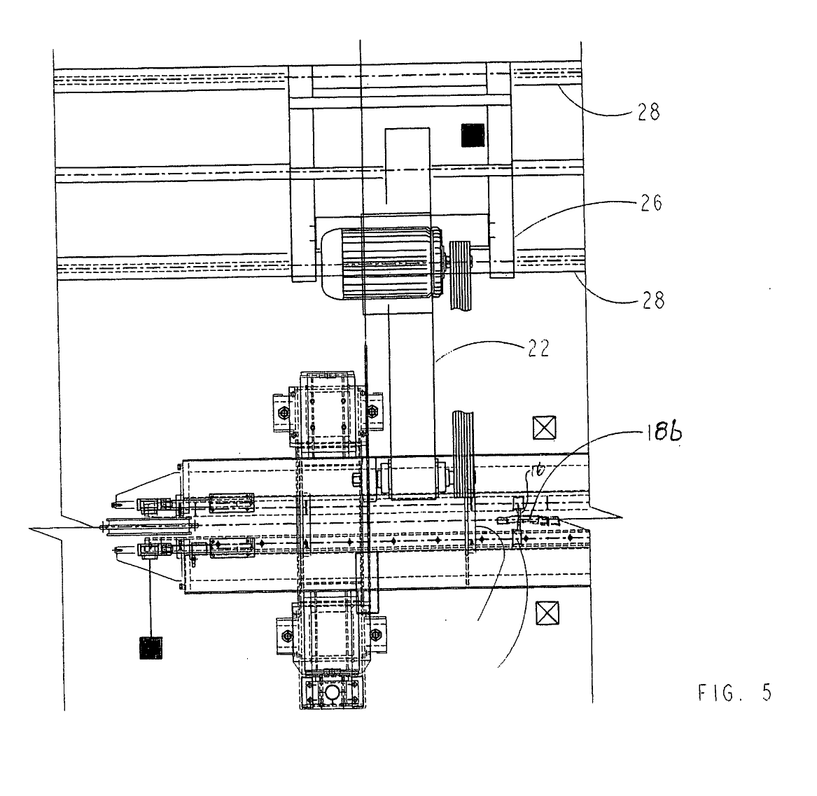

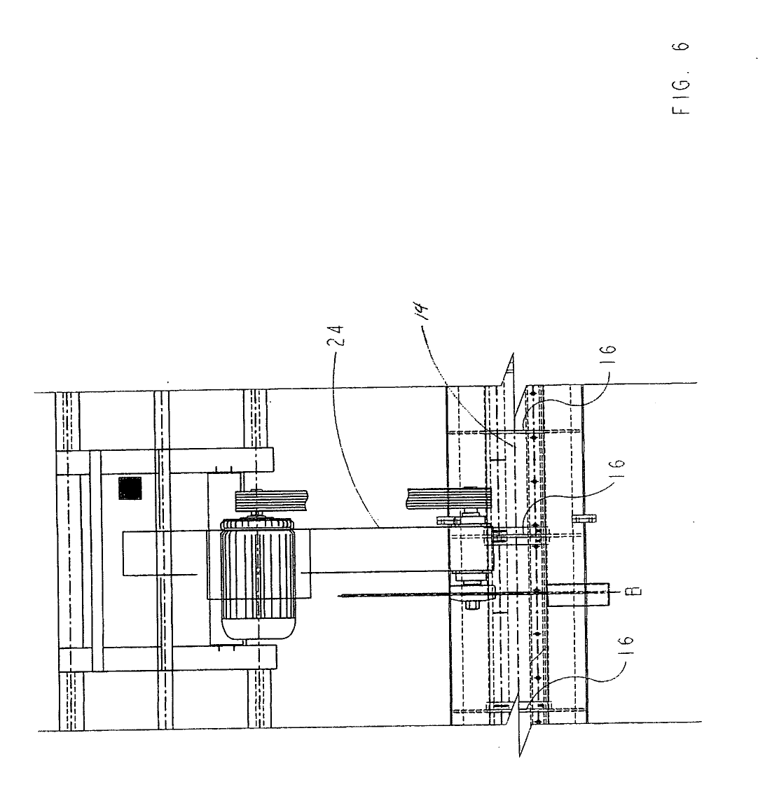

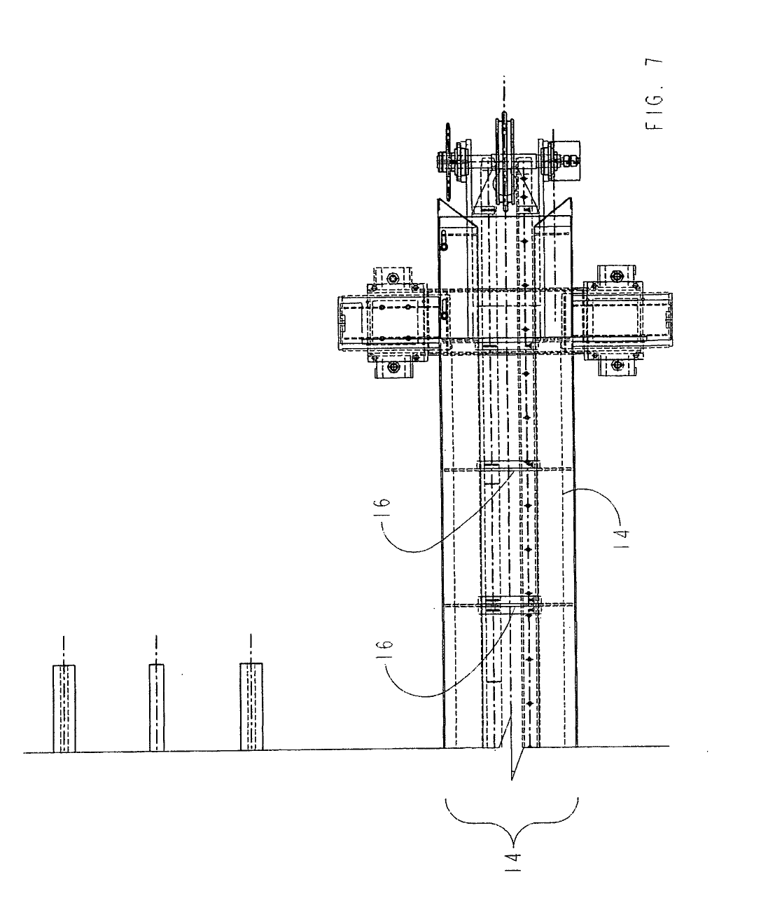

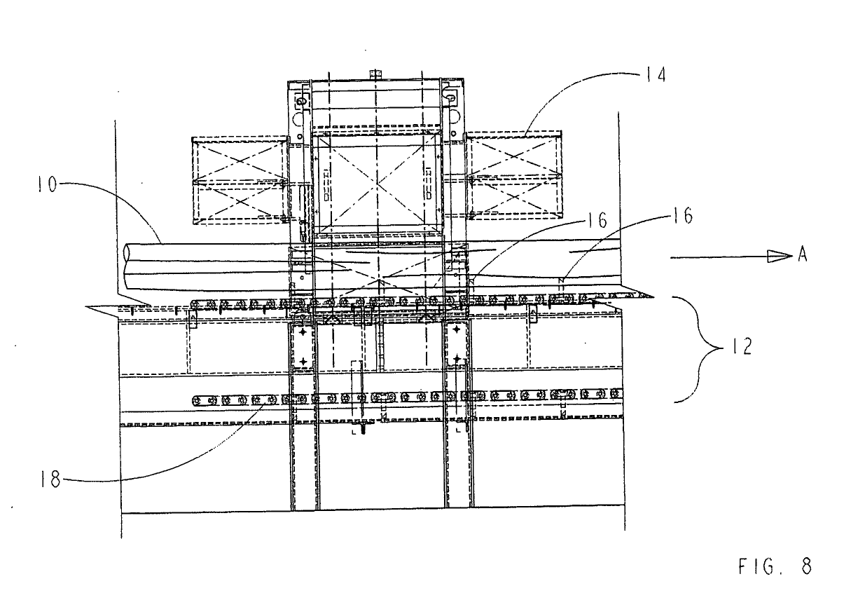

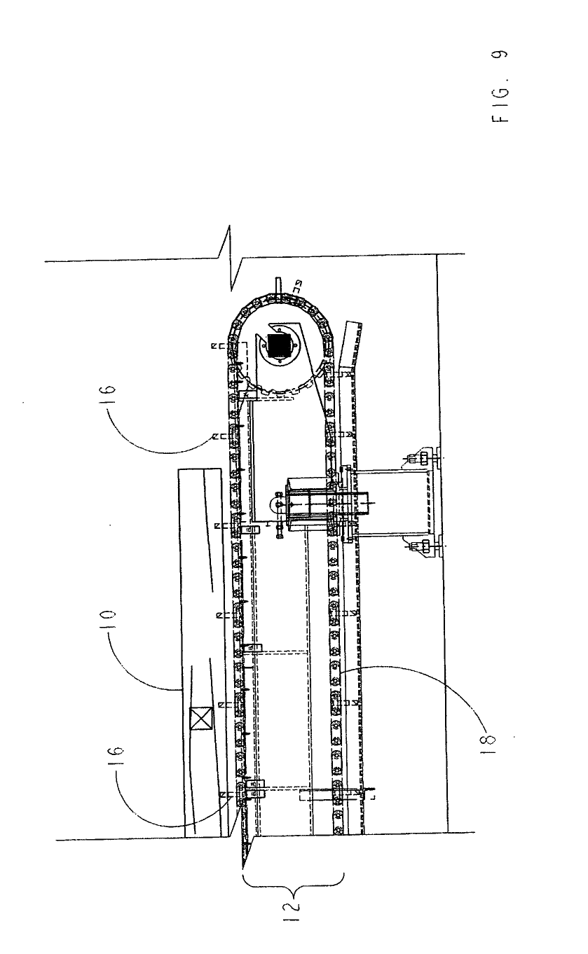

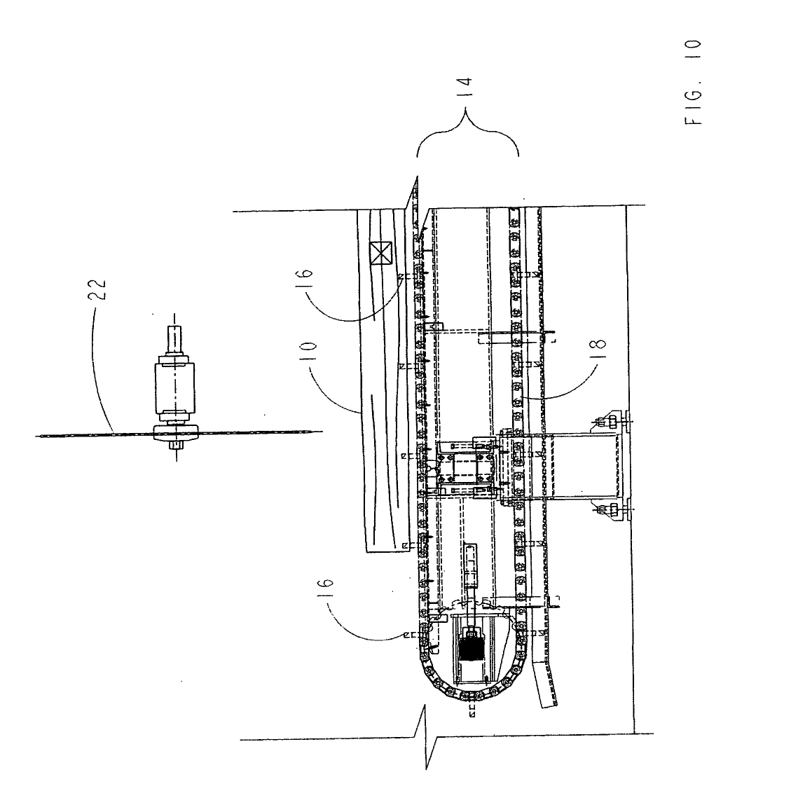

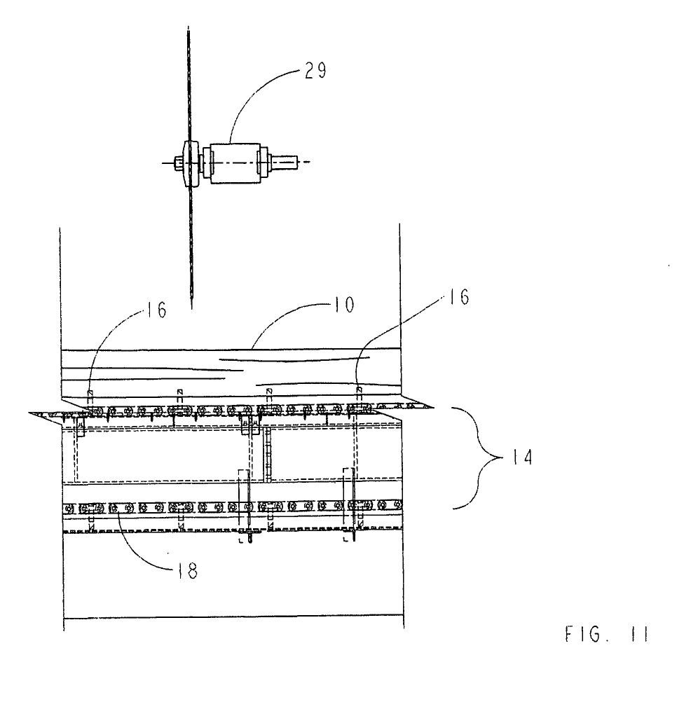

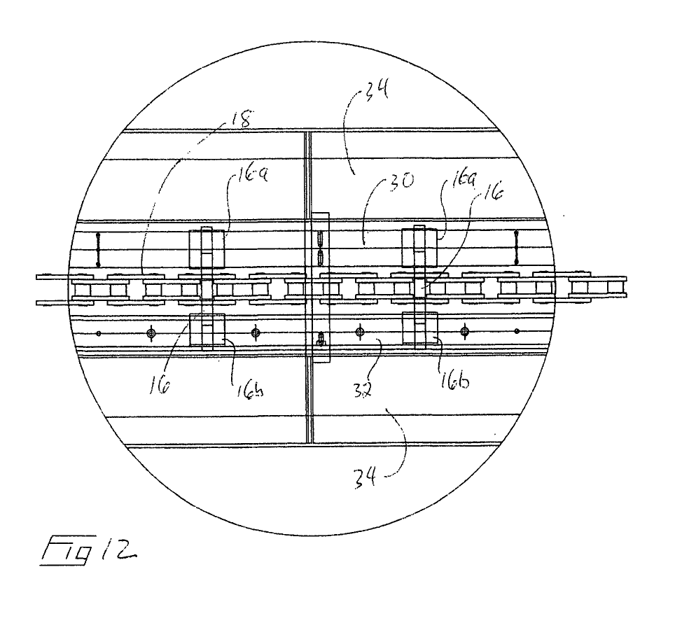

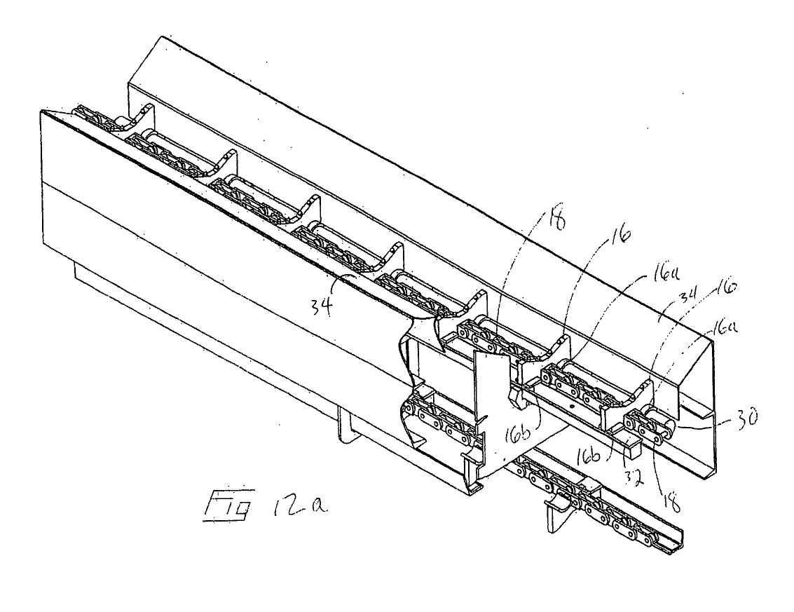

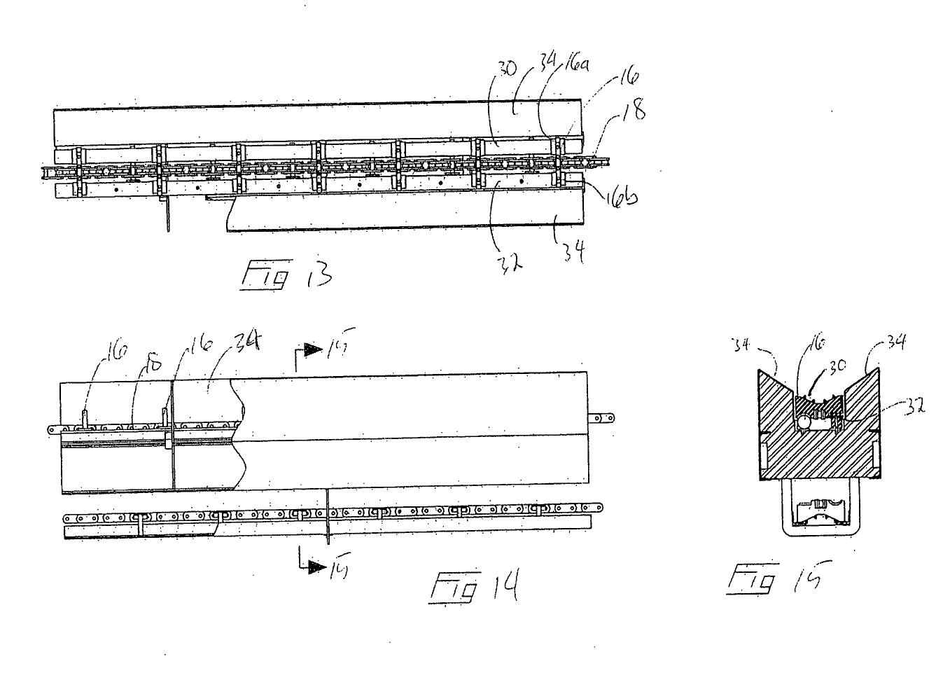

As seen in FIG. 3, while translating downstream on first conveyor 12, stem 10 passes underneath a scanner or photocell 20 which registers the location of stem 10 relative to chain flights 16 and scans the shape of the stem so as to allow determining of desired cut lines. Data from photocell 20 is transmitted by conventional means such as a conductor cable to a processor such as a computer (not shown). For each stem 10 entering first conveyor 12, the computer processes the data received from photocell 20 and produces control commands. The computer may also receive data relating to, and without intending to be limiting, saw loading, saw availability and saw positions of the saws better described below. If the data processed from photocell 20 indicates that the desired predetermined cut lines into stem 10 are co-planar with, and thus would result in cuts that would interfere with any of chain flights 16, the relative phase positions of conveyors 12 and 14 are adjusted so that the cut lines do not coincide with the location of any chain flights 16 when stem 10 reaches or it conveyed on second conveyor 14. For example, the processor may produce a control command to alternate the velocity of conveyor 14 such that when stem 10 is conveyed from conveyor 12 to conveyor 14, the position of chain flights 16 on conveyor 14 no longer are co-planar with the predetermined cut lines. The processor may alter the velocity of the conveyors even during sawing a cut, and may dynamically control conveyor velocities and corresponding tracking saws based on data relating to a variety of variables such as the saw loading, availability and position data referred to above.

Whereas on a conventional belt conveyor, stems would be free to move about after being scanned, thus impeding accurate sawing, the chain flight design of the present invention impedes stem movement once a stem is placed on either conveyor 12 or 14. Accordingly, once the relative location of stem 10 to chain flights 16 has been registered, independent stem movement is inhibited on conveyor 12 or 14 that might compromise the alignment of the relative phase position of conveyors 12 and 14 so as to avoid cut lines coinciding with chain flight locations. In particular, each chain flight 16 rests at one end on a cylindrical shaft 30 parallel to the chain by means of a conformingly curved slide or pad 16a, and at its opposite end on a planer slide-way 32, for example of UHMW polyurethane, by means of a corresponding flat slide or pad 16b. Each flight is generally v-shaped so as to center and support a stem lying on the flights on the chain. Sheeting 34 on either side of the chain may also form generally a v-shape to assist centering the stem on the flights.

After passing underneath photocell 20, stem 10 continues to translate downstream, passing linearly from conveyor 12 onto second conveyor 14. Having received the predetermined cut line data from the computer, tracking saws including for example first saw 22 and second saw 24 accelerate and move parallel to the direction A. Saws 22 and 24 are each mounted on a carriage 26 slidably mounted on to parallel guides 28. Tracking saws may be mounted on one or both sides of conveyors downstream of the scanner conveyor. Means, such as hydraulic or electric actuators are provided to accelerate and translate the saws and carriage over the guides according to instructions from the processor. The saws accelerate so as to match the translation velocity of stem 10 and so as to align the saw blades co-planar with the pre-determined cut lines on stem 10. Saws 22 and 24 are then actuated as drop saws to make cuts on the cut-lines through stem 10 while continuing to translate downstream. For example, as shown in FIG. 6, saw 24 makes a cut in plane B. The cut is not coplanar with a chain flight 16. Thus, conveyor 14 may continuously translate either at a constant or a varying velocity, uninterrupted by the sawing of stems 10. The height of stem 10 above the chain conveyors when resting on chain flights 16 ensures that the tracking saws 22 and 24 may make complete cuts through stem 10 without hitting the chain of conveyor 14.

The illustrated embodiment is by way of example only. In other embodiments tracking saws may be mounted on both sides of the conveyor 14 or multiple such conveyors. Consequently, in the example of a first upstream conveyor having a scanner, and sequential second and third conveyor sequentially downstream of the first conveyor, where tracking saws are mounted for translation alongside both the second and third conveyors, the computer would generate control signals assigning cuts to be made among the various tracking saws and to thus determine the phase relationships between the first and second conveyors and between the first and third conveyors. The controls dynamically determine cut starting points along the length of the conveyors in the conveyor system. With prior art systems the saws must return to a fixed starting point for each cut. This restricts conveyor speed on short length cuts. The system of the present invention allows saws to make a partial return and dynamically select a starting point for the individual cut.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for sawing a workpiece on predetermined cutting lines while the workpiece is being continuously transported in a downstream direction, the apparatus comprising:
a first transport means for translating the workpiece in the downstream direction;
a second transport means for translating the workpiece in the downstream direction, said second transport means cooperating with the first transport means to receive the workpiece downstream from said first transport means;
a plurality of discrete workpiece supports mounted to said second transport means, said supports extending upwardly from said second transport means such that the workpiece rests on said supports elevated above said second transport means while translating in the downstream direction;
a scanning means for determining location and characteristic data of the workpiece while the workpiece translates in the downstream direction on said first transport means, said scanning means conveying said data to a data processing and control means for determining cutting lines for the workpiece and for controlling relative phase positions of said first and said second transport means such that said cutting lines do not coincide with the position of said supports; and
a sawing means mounted on a saw transport means, said sawing means for sawing the workpiece on the cutting lines without contacting said second transport means, while the workpiece translates continuously in the downstream direction on said supports on said second transport means, said saw transport means translating said sawing means in the downstream direction.

2. The apparatus of claim 1 further comprising a plurality of discrete workpiece supports mounted in spaced array, along said down stream direction, to said first transport means, said workpiece supports extending upwardly from said first transport means such that the workpiece rests on said workpiece supports elevated above said first transport means while translating in the downstream direction.

3. The apparatus of claim 2 wherein said first transport means comprises a first conveyor chain and wherein said upstream supports are chain flights mounted to and extending above said first conveyor chain.

4. The apparatus of claim 1 wherein said second transport means comprises a second conveyor chain having a plurality of said supports mounted to said second conveyor chains

5. The apparatus of claim 4 wherein said supports are chain flights.

6. The apparatus of claim 3 wherein said chain flights are shaped to cradle the workpiece.

7. The apparatus of claim 1 wherein said data processing and control means selectively actuates downstream translation of said sawing means on said saw transport means so as to align said sawing means with the cutting lines as the workpiece and said sawing means are translated downstream in unison while said sawing means saw through the workpiece.

8. The apparatus of claim 7 wherein said sawing means comprises a first saw and a second saw, and wherein said first and said second saws are drop saws to saw through the workpiece on the cutting lines while the workpiece translates in the downstream direction.

9. The apparatus of claim 8 wherein a selectively actuable saw actuator is mounted to said saw transport means, said actuator for selectively actuating said sawing means so as to saw through the workpiece on the cutting lines and to accelerate and translate said saw transport means so as to align said sawing means with the predetermined cutting lines.

10. The apparatus of claim 9 wherein said actuator is an electric actuator.

11. An apparatus for sawing a workpiece on predetermined cutting lines while the workpiece is being continuously transported in a downstream direction, the apparatus comprising:
a first transport means for translating the workpiece in the downstream direction, said first transport means comprising a first conveyor chain having a plurality of first chain flights mounted to and extending above said first conveyor chain, said first chain flights extending above and upwardly from said first conveyor chains such that the workpiece rests on said first chain flights elevated above said first conveyor chain while translating in the downstream direction;
a second transport means for translating the workpiece in the downstream direction, said second transport means adapted to receive the workpiece downstream from said first transport means, said second transport means comprising a second conveyor chain having a plurality of second chain flights mounted to and extending above said second conveyor chains, said second chain flights extending above and upwardly from said second transport means such that the workpiece rests on said second chain flights elevated above said second conveyor chain while translating in the downstream direction;
a scanning means for detecting location and characteristics of the workpiece while the workpiece translates in the downstream direction on said first transport means, said scanning means for conveying said data to a data processing and control means for determining the predetermined cutting lines and controlling relative phase positions of said first and said second transport means such that the predetermined cutting lines do not coincide with the position of any of said chain flights; and
a sawing means mounted on a saw transport means, said sawing means for sawing the workpiece on the predetermined cutting lines without contacting said second conveyor chain while the workpiece translates continuously in the downstream direction on said second transport means, said saw transport means for translating said sawing means in the downstream direction parallel to the workpiece.

12. The apparatus of claim 11 wherein said first and said second chain flights are shaped to cradle the workpiece and thereby impede lateral movement of the workpiece relative to the first and second chains respectively.

13. The apparatus of claim 12 wherein said data processing and control means is further adapted to actuate downstream translation of said sawing means on said saw transport means so as to align said sawing means with the predetermined cutting lines as the workpiece and said sawing means are translated downstream in unison while said sawing means saw through the workpiece.

14. The apparatus of claim 13 wherein said sawing means comprises a first and a second saw, said first and said second saw adapted to actuate as drop saws to saw through the workpiece on the predetermined cutting lines while the workpiece continues to translate in the downstream direction.

15. The apparatus of claim 14 wherein a selectively actuable saw actuator mounted to said saw transport means, said actuator adapted to selectively actuate said sawing means so as to saw through the workpiece on the predetermined cutting lines.

16. The apparatus of claim 15 wherein said actuator is a hydraulic actuator further adapted to accelerate and translate said saw transport means so as to align said sawing means with the predetermined cutting lines.

17. The apparatus of claim 15 wherein said actuator is an electric actuator further adapted to accelerate and translate said saw transport means so as to align said sawing means with the predetermined cutting lines.

18. The apparatus of claim 1 wherein said sawing means includes tracking saws mounted on said saw transport means on both sides of said second transport means.

19. The apparatus of claim 1 wherein said second transport means includes a plurality of sequentially cooperating downstream conveyors, and wherein said data processing and control means controls said relative phase positions of each conveyor of said plurality of conveyors.

20. The apparatus of claim 19 wherein said phase positions of said each conveyor of said plurality of conveyors are each independently controlled by said data processing and control means.

21. The apparatus of claim 1 wherein said sawing means and said saw transport means provide saw status data to said processing and control means comprising data relating to saw availability, saw loading and relative saw position relative to said second transport means, and wherein said processing and control means also adjust said relative phase positions according to said saw status data.

22. The apparatus of claim 21 wherein said second transport means includes a plurality of sequentially cooperating downstream conveyors, and wherein said data processing and control means controls said relative phase positions of each conveyor of said plurality of conveyors.

23. The apparatus of claim 1 wherein a conveying speed of said second transport means is variable and dynamically controlled by said processing and control means.

24. The apparatus of claim 19 wherein a conveying speed of said second transport means is variable and dynamically controlled by said processing and control means.

25. The apparatus of claim 1 wherein starting points for tracking saws in said sawing means making cuts in said workpiece are dynamically controlled by said processing and control means so as to variably position said starting points in optimized positions along said second transport means.

26. The apparatus of claim 19 wherein starting points for tracking saws in said sawing means making cuts in said workpiece are dynamically controlled by said processing and control means so as to variably position said starting points in optimized positions along said second transport means.
